(19) United States
(12) Patent Application Publication
(10) Pub. No.: US 2026/0154878 A1
(43) Pub. Date: Jun. 4, 2026

(54) CONTENT COMPANION ON AN EXTENDED REALITY DEVICE

(71) Applicant: GOOGLE LLC, Mountain View, CA (US)

(72) Inventors: John Patrick Guiseppi, II, Los Angeles, CA (US); Neil Parris, Los Angeles, CA (US); S. Jonathan Zepp, Los Angeles, CA (US); Katherine Faith Erdman, Mountain View, CA (US); Maxwell Spear, San Francisco, CA (US); Tuan Anh Nguyen, San Jose, CA (US)

(21) Appl. No.: 19/374,442

(22) Filed: Oct. 30, 2025

Related U.S. Application Data
(60) Provisional application No. 63/726,922, filed on Dec. 2, 2024.

(51) Int. Cl. G06T 11/60; G06F 3/01; G06F 3/16; G06N 5/04

(52) U.S. Cl. CPC G06T 11/60; G06F 3/013; G06F 3/017; G06F 3/167

(57) ABSTRACT

According to at least one implementation, a method includes causing display of first content on a device and identifying an input from a user of the device. The method further includes, in response to identifying the input, identifying a state of the first content and obtaining second content from a model, the model configured to determine the second content based on the input and the state of the first content. The method further includes causing display of the second content on the device.

### CROSS-REFERENCE TO RELATED APPLICATION

This application claims the benefit of U.S. Provisional Application No. 63/726,922, filed Dec. 2, 2024, the disclosure of which is incorporated herein by reference in its entirety.

### BACKGROUND

A wearable device or an Extended Reality (XR) device encompasses a range of technologies, including Virtual Reality (VR), Augmented Reality (AR), and Mixed Reality (MR), that blend the physical and virtual worlds to create immersive experiences for a user. These devices can display various types of content, such as videos or interactive games, which can be presented as two-dimensional (2D) or three-dimensional (3D) elements within the user's augmented or virtual environment. To interact with this content, a user can provide input to the XR device through a variety of mechanisms. For instance, input can be received through sensors and cameras that track hand gestures, head movements, and eye gaze, or through microphones that capture voice commands. Additionally, users can interact with the virtual environment using handheld controllers or other peripheral devices.

### SUMMARY

Systems and methods described herein provide a content companion system for a device that enhances media consumption by making the content interactive. The system displays first content, such as a video or a game, and monitors user input, such as voice commands, gestures, and/or gaze. A model, trained on the media content itself, processes this input along with the current state of the first content to understand the user's intent. Based on this intent, the system retrieves and causes a display of relevant second content, creating a more immersive and informative experience by providing context-aware information on demand.

In some aspects, the techniques described herein relate to a method including: causing a first display of first content on a device; identifying an input from a user of the device; in response to identifying the input, identifying a state of the first content; obtaining second content from a model, the model configured to determine the second content based on the input and the state of the first content; and causing a second display of the second content on the device.

In some aspects, the techniques described herein relate to a computing system including: at least one processor; a computer-readable storage medium operatively coupled to the at least one processor; and program instructions stored on the computer-readable storage medium that, when executed by the at least one processor, direct the computing system to perform method, the method including: causing a first display of first content on a device; identifying an input from a user of the device; in response to identifying the input, identifying a state of the first content; obtaining second content from a model, the model configured to determine the second content based on the input and the state of the first content; and causing a second display of the second content on the device.

In some aspects, the techniques described herein relate to a computer-readable storage medium having program instructions stored thereon that, when executed by at least one processor, direct the at least one processor to perform a method, the method including: causing a first display of first content on a device; identifying an input from a user of the device; in response to identifying the input, identifying a state of the first content; obtaining second content from a model, the model configured to determine the second content based on the input and the state of the first content; and causing a second display of the second content on the device.

The accompanying drawings and the description below outline the details of one or more implementations. Other features will be apparent from the description, drawings, and claims.

### BRIEF DESCRIPTION OF THE DRAWINGS

FIG. 1 illustrates a computing environment that supports a content companion according to an implementation.

FIG. 2 illustrates a method of operating a device to provide a content companion for a user according to an implementation.

FIG. 3 illustrates an operational scenario of updating a display of content on a device according to an implementation.

FIG. 4 illustrates an operational scenario of operating a model to select second content according to an implementation.

FIG. 5 illustrates an operational scenario of displaying second content on a device according to an implementation.

FIG. 6 illustrates an operational scenario of providing recommendations for a user according to an implementation.

FIG. 7 illustrates a computing system to provide a content companion according to an implementation.

### DETAILED DESCRIPTION

An extended Reality (XR) device encompasses a range of technologies that blend the physical and virtual worlds, creating immersive experiences. This includes Virtual Reality (VR) devices, which fully immerse users in a computer-generated environment; Augmented Reality (AR) devices, which overlay digital information onto the real world; and Mixed Reality (MR) devices, which merge real and virtual elements interactively. XR devices are used in various gaming, education, training, video entertainment, and remote collaboration applications. They enhance how users perceive and interact with their surroundings by integrating digital content seamlessly with the physical world.

Input on an XR device can be received through sensors, controllers, and tracking systems. Users can interact with the virtual environment using handheld controllers, motion sensors, eye-tracking, gestures, voice commands, or other input mechanisms. The device's cameras and sensors can track the user's head movements and position, as well as detect hand movements and gestures. In some examples, XR devices may utilize body tracking to capture the movement of the entire body or specific parts, such as hands, for more precise interaction.

Display on an XR device can be provided through optical see-through or video see-through methods. Optical see-through devices, such as AR glasses, feature transparent lenses that allow users to view the physical world directly, with digital elements overlaid via projectors or waveguides. In contrast, video see-through devices, including VR headsets, can use external cameras to capture real-world video and display the captured video on internal screens, combining the video with virtual elements to create a seamless augmented view. Both methods enable users to interact with digital content while remaining aware of their physical environment. However, conventional systems for providing supplemental information (and content) for media content face technical challenges related to computer functionality. For instance, systems that rely on generic, web-scale search models to interpret user queries in the context of time-varying media (e.g., a video) often exhibit high latency, as processing a generalized query and vast datasets is computationally intensive. This processing overhead can be particularly problematic on resource-constrained devices, such as XR headsets, leading to delayed responses that degrade system performance. Furthermore, the accuracy of these generic models is limited, as they lack the specific contextual understanding of the media content itself, resulting in the retrieval of irrelevant or incorrect information. These functional limitations arise because conventional approaches are not specifically adapted to the unique computational demands of real-time, context-aware information retrieval for dynamic media. Additionally, conventional approaches may not include, or be limited to, information associated with a particular subject or specific content (e.g., movie or video game). A technical problem therefore exists in identifying and presenting content on an XR device in a manner that utilizes the device's form factor.

To address the technical problems of high latency and inaccurate information retrieval inherent in systems using generic, web-scale models, a technical solution is provided that utilizes a specialized, content-specific computational model. This purpose-built model, which is configured using data directly associated with the primary media content, provides a more efficient and accurate method for processing user inputs in real-time. By operating on a focused and curated knowledge base, the model significantly reduces the computational overhead and processing latency associated with interpreting user queries. This technical arrangement improves the functioning of the computing device, particularly a resource-constrained XR device, by enabling faster, more accurate, and contextually relevant retrieval and display of secondary content, thereby overcoming the performance limitations of conventional systems. The systems and methods described herein provide a content companion system for a device that enhances media consumption by making the media interactive while a user views primary content, such as a video or game. The system monitors user inputs, such as voice commands, gestures, and/or gaze, and uses a specialized model trained on the media content itself to understand the user's intent. Based on this intent, the device retrieves and displays relevant secondary content, such as behind-the-scenes information or interactive 3D objects, creating a more immersive and informative experience for the user.

In at least one technical solution, content is displayed on an XR device and updated based on input provided by the user and a model associated with the content. In some implementations, the content includes a video. In some implementations, the content comprises a game. In some implementations, video and gaming content can be combined as part of a single media item. In at least one example, the device can display a video for the user. A video can be displayed on an XR device as a 2D or 3D element within the virtual or augmented environment. The XR device can process the video using its graphics processing unit, adapting the playback to the user's perspective by tracking head and eye movements for a realistic experience. The video can be mapped onto a virtual screen or a 360-degree environment for immersive viewing, aligning seamlessly with the user's surroundings. While displaying the video, the device can monitor for user input. Input on an XR device can be provided through various methods such as hand tracking, voice commands, eye tracking, motion controllers, or external devices like keyboards. Sensors and cameras capture the user's movements or gestures, while microphones and touch interfaces enable intuitive interaction within the immersive environment.

In response to receiving input, such as a voice question associated with the video, the device can process the input to determine an action associated with the video content. In some implementations, voice input for an XR device is processed using a combination of microphones, speech recognition, and natural language processing (NLP). The device can capture the user's voice through a microphone, converting the audio into a digital signal. In some examples, speech recognition algorithms analyze the signal to identify words and phrases interpreted by the NLP system, thereby determining the user's intent. Intent can refer to the purpose or goal behind a user's input, representing what they aim to achieve or convey through their text or speech. In some examples, the intent can be derived from voice input, gestures, controller inputs, or some other input, including combinations thereof. In some examples, the intent is derived locally at the XR device. In some examples, the intent is determined at one or more other servers or companion devices that process the various user inputs to determine the user's intent. Once the intent is understood, the XR device maps the intent to a corresponding action, such as opening new content, answering a user question, or providing some other action associated with the content. In some implementations, in addition to or in place of using the user's voice to determine an action in association with the content, the device can use other context, including gestures, conversation history, content identified via screen sharing, or some other context. For example, the user can point at something in the content, and the device can display new content based on the point. By processing the user's input against a computational model configured with a curated and domain-specific knowledge base associated with the first content, the system reduces the processing latency and computational resources required to identify and obtain the second content when compared to systems that rely on generalized, web-scale search models. As a technical effect, this specific technical arrangement improves the functioning of the device by enabling faster and more accurate retrieval of contextually relevant data. Based on the user's voice or gesture input, the device can dynamically adjust the content provided to the user, thereby providing an immersive experience. For example, the first content can include a first video. In response to user voice input, the device can overlay a three-dimensional object as second content in the user's view to provide a more immersive experience.

In some implementations, the device can use NLP models and contextual processing to identify the second content from the user input. For example, when the user provides speech input, the speech input can be mapped to an action (second content) that the user does not expressly request. For example, the user can say, “That is a cool hat,” referencing a hat displayed in the first content. In response to the input, the system can map the input to second content that provides additional information about that hat, provides a 3D object or scene, provides new video, acts in a video game, or provides some other content to the user. Using the comment about the hat, a 3D scene can be displayed that corresponds to the hat. As at least one technical effect, the user's intent can be inferred to display the new content (e.g., the 3D scene). Although not expressly indicating a desire for the new or second content, the system can infer that the second content should be displayed.

In some implementations, the model is configured (i.e., trained) using the content. In some examples, the training process begins by identifying a dataset of voice commands (or gestures) paired with corresponding actions, which enables the training of a model to take actions based on user input. The model first uses a speech-to-text system, trained to accurately transcribe audio into text, accounting for variations in accents and speech patterns. The text is then passed to a natural language processing (NLP) model trained to understand intent by mapping commands to potential actions (e.g., displaying different portions of content). Using supervised learning, the model learns from examples where voice input is linked to specific outputs, such as causing content to be displayed, providing a summary to the user, providing an interactive element, or some other action. The system can be tuned and validated on diverse test cases to configure the model to generalize effectively and execute actions reliably for the user viewing the media. In some examples, the model can use fine-tuning. Fine-tuning in machine learning can take the pre-trained model and adapt the model to a specific task or dataset by further training the model with a lower learning rate and task-specific data. This can be specific to the media of the game and/or media associated with video.

In some implementations, the first content (e.g., a long-form video) can be associated with metadata that prompts the user while viewing the first content. The prompts are related to various second content or supportive content for the first content. For example, the metadata can include timestamps that provide prompts at different times during the first content. When the user provides input associated with a prompt, the second content for that prompt can be displayed. For example, at a timestamp during a video, the device can provide a visual prompt for “Click the hat for a secret.” In response to the user invoking the prompt (e.g., via voice or gesture), the second content can be displayed associated with the hat (e.g., a 3D visual scene). Although demonstrated as a timestamp, the metadata could trigger prompts based on locations in a game, based on the user's gaze associated with the content, or triggered by some other means. In some examples, the metadata and prompts can be assigned by the media company distributing the content. The user's inputs (voice, gesture, etc.) can then be processed to invoke the content related to the various prompts. The prompts can provide keywords, phrases, gestures, and the like that can invoke the corresponding content or action (e.g., the gesture selecting the hat).

In at least one example, a system can display primary content, such as a video or game, on a wearable extended reality (XR) device. While the user engages with this content, the system actively monitors for various inputs, including voice, gaze, and physical movements. To access supplementary information, the user can perform a specific gesture, such as pointing at an object or character within the first content. This action signals the user's intent to the system, prompting the system to retrieve and display related secondary content.

The secondary content can be presented in multiple formats to create an immersive and informative experience. The system may display the second content as an overlay, placing text, images, or an interactive three-dimensional object on top of the primary content without entirely obscuring it. Alternatively, the secondary content could temporarily replace the first, such as showing a behind-the-scenes video clip. In other implementations, the information can be delivered as an audio-only summary from a disembodied voice, as an abstract visual form, such as a collection of light, or by an on-screen character who acts as a companion to the media.

Once the user has finished interacting with the secondary content, the system can be configured to transition back to the primary viewing experience seamlessly. If the supplementary material was an overlay, the second content may disappear from the display. If the second content had temporarily replaced the original media, the system would resume the video or game from the point at which the media was paused or interrupted. This functionality ensures that the user's engagement with the main content is not interrupted, allowing for a fluid and enriched viewing experience.

For example, a user can be watching a fantasy movie on XR glasses when a dragon appears on screen. Intrigued by the dragon, the user can point directly at the creature. The system recognizes this gesture and overlays a detailed, interactive 3D model of the dragon. The user can use further gestures to rotate the model, zoom in on the model's features, and read production notes about the complex animation process. When the user is finished exploring, the user can provide a dismissal gesture (or another command) to remove the overlay, and the movie continues to play, enriching your viewing experience without ever leaving the film's world.

In some implementations, the model can be generated or configured by the content creator who provides a supervised learning approach on a curated dataset. This dataset is created by collecting various user inputs, such as voice commands or gestures, and pairing them with the desired corresponding actions or outputs, which often involve displaying specific secondary content. The model learns to map these inputs to specific outputs, which correspond to user intent within the context of the primary media. This process enables the creation of models that are finely tuned to a specific piece of content, such as a particular movie or game, along with the accompanying supplemental material.

In some examples, the state of the first content, such as a specific timestamp in a video or a location within a game, provides context that the model uses in conjunction with the user's input. This can allow the system to disambiguate requests and deliver highly relevant information. For example, suppose a user points at a character and asks, “Who is that?” In that example, the model can reference the current timestamp of the video to identify which specific character is on screen at that moment, ensuring the model provides the correct actor information. The first content can also be associated with metadata tied to these states, which can trigger interactive prompts or define which specific supplementary materials. like a behind-the-scenes clip or a 3D model, are available at that precise point in the media, enabling content creators to build a deeply context-aware experience.

Once trained, the model can be configured to receive two types of real-time information: the user's input (e.g., a voice query, a pointing gesture) and the current state of the first content (e.g., a specific timestamp in a video, a location in a game). By processing these two inputs together, the model determines the user's intent and, in response, outputs the appropriate second content. This second content is then displayed to the user, for instance, as an informational overlay or a behind-the-scenes video clip.

In some implementations, a system can be configured to create a custom knowledge base for a specific piece of first content, such as a movie or video game. As a technical effect, this approach reduces computational overhead and latency by constraining the search space, making real-time, context-aware processing feasible on resource-constrained devices. A knowledge base can be defined as a repository of curated data, such as facts, rules, and relationships about a specific domain, that is organized for efficient retrieval and use by a computer system to perform tasks like answering queries or generating responses. This knowledge base can be constructed by processing various related materials, including scripts, production notes, behind-the-scenes video footage, and/or publicly available data associated with the content (e.g., a Wiki). The model is then trained on this curated dataset using supervised learning, where the model can learn to map user inputs (e.g., voice queries, gestures) to relevant excerpts from the knowledge base. The second content, which is generated in response to user input, can take multiple forms. The second content may include displaying pre-existing video clips, such as supplemental interviews with the cast, or rendering interactive 3D models of objects from the first content. Additionally, the system can utilize a Large Language Model (LLM) to generate new, text-based responses or summaries, drawing directly from the information within the specialized knowledge base to answer user questions contextually.

For instance, configuring (i.e., training) the model for a specific movie can involve creating a dataset that pairs timestamps from the movie with various user inputs and corresponding secondary content. This dataset would include labeled examples, such as a timestamp where a specific prop appears, linked to a user query like “What is that item?” and the desired output, which could be a 3D model of the prop or production notes about the design. The model can also be trained on behind-the-scenes footage, scripts, and actor interviews, learning to associate specific scenes or dialogue with relevant supplementary video clips. Furthermore, a LLM component can be fine-tuned on the movie's script and related textual data, enabling it to generate real-time, context-aware answers to user questions, such as summarizing a character's backstory up to that point in the film. Through this supervised learning process, the model learns to map a combination of user input and the movie's current state to the appropriate secondary content, whether content is a pre-existing video, a 3D object, or a dynamically generated text response.

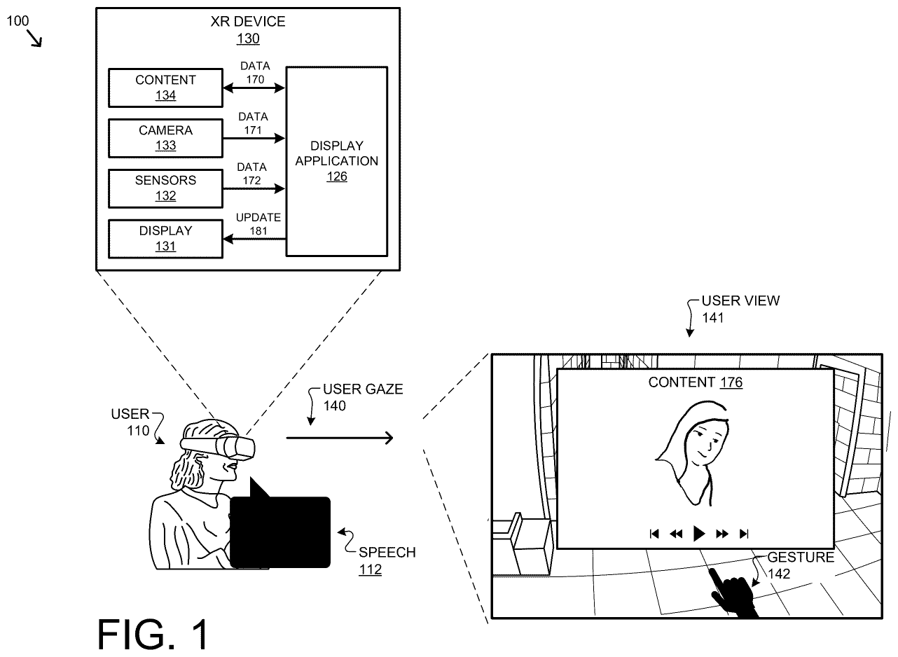

FIG. 1 illustrates a computing environment 100 that supports a content companion on an XR device according to an implementation. Computing environment 100 includes user 110, speech 112, XR device 130, user gaze 140, and user view 141. XR device 130 includes display 131, sensors 132, camera 133, application 134, and display application 126. XR device 130 further includes data 170, data 171, data 172, and update 181. User view 141 is representative of the view for user 110 and includes gesture 142 and content 176, which is representative of content displayed for a user. The content can consist of a game, a movie, 2D or 3D media, or other content displayed by XR device 130. Although demonstrated as being performed on XR device 130, display application 126 can be performed wholly or partially on one or more second devices. These second devices can include servers, companion devices (e.g., smartphones), or other devices, including combinations thereof.

In computing environment 100, user 110 interacts with XR device 130, which displays content 176 in user view 141. While viewing the content 176, user 110 can provide various inputs, such as speech 112, gesture 142, or user gaze 140, which are monitored by XR device 130 using sensors 132 and camera 133. The display application 126 on the XR device 130 processes these inputs to determine the user's intent. Based on the determined intent and the current state of content 176, display application 126 identifies and retrieves secondary content. Display application 126 then provides update 181 to cause the display 131 to show the secondary content, thereby enriching the user's experience with relevant, context-aware information.

Turning to the elements of computing environment 100, XR device 130 includes display 131, which is a screen or projection surface that presents immersive visual content to user 110, merging virtual elements with the real world or creating a completely virtual environment. XR device 130 further includes sensors 132, including accelerometers, gyroscopes, magnetometers, depth, infrared, and proximity sensors. The sensors can be used to monitor the user's physical movement, identify depth information for other objects, identify surfaces or objects, identify eye movement for the user, or provide some other operation. XR device 130 also includes camera 133 that can capture the real or physical environment to overlay virtual objects (e.g., application interfaces) seamlessly and track the movements of user 110 and surroundings to enable accurate interaction within the augmented or virtual space. In some examples, camera 133 can be positioned as an outward view to capture the physical world associated with the user's gaze. Display 131 can be used to display information using optical see-through or video see-through methods. Optical see-through devices, like AR glasses, have transparent lenses that let users view the real world directly, with digital elements overlaid via projectors or waveguides. In contrast, video see-through devices, including VR headsets, can use external cameras to capture real-world video and display captured video on internal screens, combining the video with virtual elements to create a seamless augmented view. Both methods can enable users to interact with digital content while remaining aware of their physical environment.

As illustrated in FIG. 1, content 176 is displayed for user 110. While displaying content 176, XR device 130 monitors for voice input using built-in microphones and voice recognition software that listens for commands or requests from user 110. XR device 130 can detect gesture input through cameras and sensors, such as depth sensors or hand-tracking systems, which capture the user's movements and interpret them using machine learning models to execute actions associated with the comment. For example, user 110 can provide voice input that provides, “When was this character introduced?” Upon receiving the input, display application 126 processes the input to identify the user's intent. The speech is converted to text and is analyzed by an NLP model to determine the user's intent by identifying keywords, context, and patterns. Once the intent is identified, the system maps it to corresponding actions or responses. In some implementations, the device can map or match the intent to second content (e.g., the scene where the actress is introduced). Display application 126 can cause display of the second content to support the request. The second content can include video, text, a three-dimensional object (e.g., expanded object from a scene), or some other content. In some implementations, the second content replaces the first content. In some implementations, the second content is overlaid on the first content (e.g., a text summary overlaid on the video).

In some implementations, the model for display application 126 is trained using a curated dataset specific to the first content. For content like a movie, this dataset pairs user inputs, such as voice commands or gestures, with corresponding secondary content, such as behind-the-scenes clips, 3D models of props, or textual information. For a video game, the training data might link in-game events or user queries about game mechanics to tutorial videos, lore summaries, or interactive guides. This supervised learning approach allows the model to learn the mapping between a user's intent, the current state of the first content (e.g., a movie timestamp or a game location), and the appropriate secondary content to display.

For instance, to train a model for a specific video game, developers can create a dataset that captures various in-game scenarios. This dataset could include labeled examples where a player is in a specific location and asks, “How do I solve this puzzle?” paired with a video clip demonstrating the solution. Similarly, a player's gesture pointing at a non-player character could be linked to a text overlay providing that character's backstory. The model is trained on this data to recognize patterns between player input, game state (e.g., location, inventory, current quest), and the relevant supplementary content, enabling the model to provide contextual assistance and enrich the gaming experience in real-time.

In some examples, display application 126 can generate text-based content using a LLM that has been configured on a knowledge base specific to the first content. A knowledge base can be defined as a structured repository of curated data, such as scripts, production notes, video clips, and character backstories, organized for efficient retrieval by a computer system to generate context-aware responses. For instance, while a user is watching a movie, they may ask, “What is the main character's backstory?” In response, display application 126 processes the voice input to identify the user's intent. Display application 126 then queries the language model, which draws upon the model's specialized knowledge base, containing information from the script, production notes, and other related materials, to generate a text-based summary of the character's history. This summary can then be displayed to the user as an overlay on the video (or a replacement of the video), providing a contextual answer without interrupting the viewing experience. In some examples, the model can be more efficient as the model draws from a knowledge base associated with the specific content. As a technical effect, rather than processing large datasets, the dataset can be reduced to the information associated with the content.

In some implementations, display application 126 can further be configured to use the outward-facing cameras of XR device 130 to identify a physical object in the user's environment and, instead of performing a generic web search, generates a response that is thematically tied to the primary content being viewed. For instance, if user 110 is watching a nature documentary about marine life and points at a physical beach ball in their room, the model (display application 126), configured on the documentary's knowledge base, could generate a response explaining how ocean currents can carry inflatable objects for thousands of miles, thereby linking the user's physical environment to the digital content in a meaningful way.

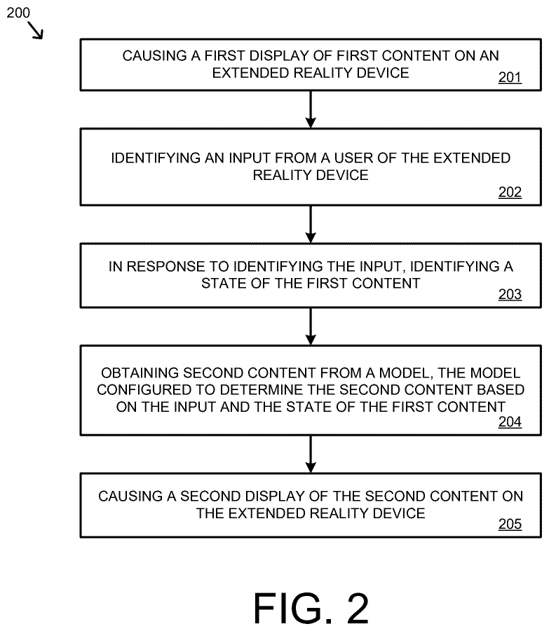

FIG. 2 illustrates method 200 of supporting a content companion on an XR device according to an implementation. The steps of method 200 are referenced parenthetically in the paragraphs that follow with reference to systems and elements of computing environment 100 of FIG. 1. An XR device can perform method 200 in some examples. In some examples, method 200 can be performed using split computing, including the XR device, a companion device (e.g., smartphone or tablet), a server, or some combination thereof. Although demonstrated using a wearable XR device, in some examples, method 200 can be performed by other computing devices, such as smart TVs, tablets, smartphones, or other computing devices capable of providing first content and supplementing the first content with second content.

Method 200 includes causing (201) a first display of first content on an extended reality device and identifying (202) an input from a user of the extended reality device. In some implementations, the device can be configured with one or more microphones that capture the speech input of the user while displaying the first content. For example, the extended reality device can display a video and identify user speech input. In some examples, the user can provide gestures (or controller inputs) identified using one or more sensors on the device, in addition to or in place of the speech input. For example, the sensor can determine when the user points or provides other input, selecting an object in the content or an object in the physical space for the user.

In response to identifying the voice input, method 200 further includes identifying (203) a state of the first content. The term state can refer to a specific, identifiable condition of the first content at a given moment, providing a contextual snapshot for processing user input. For instance, a state can be a particular timestamp in a video, a location within a game, or the set of on-screen elements at a specific point in time.

Method 200 further includes obtaining (204) second content from a model, the model configured to determine the second content based on the input and the state of the first content. In some implementations, method 200 can use a model that identifies intent from the user's speech or gestures and correlates that intent to an action. In some examples, the action includes a display of second content. In some implementations, the model is configured (i.e., trained) on a training set that links or maps different user inputs to other content portions. For example, a user may provide speech while watching a movie, asking how a movie scene was filmed. In response to the request, the system or application can perform NLP to identify the user's intent and map the intent to associated content. The intent of the user can also be identified using various models that capture the user's speech, gestures, or other inputs to determine the intent associated with the action. This content can include behind-the-scenes content, a written description, images, or other content related to the user request. Once the second content is determined, method 200 further includes causing (205) a second display of the second content on the extended reality device.

For instance, a user can watch a movie on an XR device, where the movie is anchored or overlaid on a wall of the user's environment. While watching the movie, the user can provide speech input, requesting additional information about how a scene was filmed. The system or application can process the speech using NLP to identify the user's intent and map the intent to content available in association with the movie, such as a behind-the-scenes segment or deleted scene. Once identified, the behind-the-scenes segment can be displayed for the user. In some implementations, the second content replaces the first content. In some implementations, the second content is overlaid on the first content. Although demonstrated as another video, the content can include text, a three-dimensional object or objects, or some other content. For example, based on a user gesture, a three-dimensional object can be displayed for the user, wherein the user can interact with or manipulate the object using additional gestures. As at least one technical effect, first content can be provided to a device enriched using additional content triggered based on natural language or gestures from the user of the device.

In some implementations, the model for determining the content displayed for the user is configured (or trained) by collecting a dataset of voice commands, transcriptions, and the corresponding XR display actions or content. The speech can first be processed by a speech-to-text model trained to transcribe user input. The transcriptions are then passed to an NLP model trained on domain-specific data to understand user intent. The model learns to map the recognized intents to XR-specific actions, such as rendering 3D objects, adjusting the environment, or displaying relevant multimedia. For example, specific language can be used to trigger the display of extra content in association with a movie or provide an interactive portion of content. The model can be refined over time by utilizing user inputs and matching the inputs to different content using feedback from one or more users, with user permission.

In some implementations, the user can reference physical objects not displayed as content by the device. For example, the user can reference an object on a table in the user's physical environment and ask for a description of the object. The model can identify the object using the outward-facing cameras and process the object using the model trained on the content. Rather than performing a web search, the system can generate a response to the user request using the model trained on the content. Thus, while the user references an object in the physical environment, the response is generated based on the model tailored to the content.

In some examples, the XR device can present the second content as a disembodied summary or voice. Disembodied refers to an abstract or detached concept that exists independently of any physical form or tangible representation (e.g., a voice providing the information or content to the user). In some examples, the XR device can provide the second content in the abstract, showing an amorphous embodied form, such as an abstract collection of light, energy, or emotion to highlight or emphasize specific digital or physical objects as part of the second content. For example, a ray of light can be used to highlight an object in the first content or demonstrate something to the user. In some examples, the second content can comprise a character that appears on the screen to provide the required information (e.g., actor information, summary of other plot points, etc.). In some examples, the second content can comprise a character (e.g., human representation) that provides the information to the user associated with the voice, gesture, or other input. As a technical effect, the system can act as an additional character or companion to the media content, providing the user with further information or context. The additional companion can provide content based on the user's inputs (voice, gestures, etc.) and training on the media to provide more immersion or entertainment.

In some implementations, the model can be trained to provide second content using a curated knowledge base derived from the first content. For example, if the first content is a movie, the knowledge base can be created by processing the movie script, production notes, cast interviews, and related behind-the-scenes video footage. Using this information, a supervised learning dataset is constructed by pairing potential user inputs with corresponding outputs. For instance, a specific timestamp in the movie showing a unique prop could be linked to a user query like, “What is that object?” and paired with a pre-existing 3D model of the prop or a behind-the-scenes video clip detailing the prop's creation. The model is trained on this dataset to map the combination of user input and the state of the first content to the appropriate second content.

Furthermore, the system can utilize an LLM to generate new content in real-time. This LLM can be fine-tuned on the text-based portions of the knowledge base, such as the movie script and production notes, enabling the model to generate contextually aware summaries or answer user questions dynamically. For example, in response to the user asking, “What is the character's motivation here?” the LLM can analyze the current scene in the first content, reference a specialized knowledge, and generate a new, text-based explanation. This allows the system to provide a broader range of second content, combining pre-generated assets like videos and 3D models with dynamically generated responses for a more comprehensive and interactive experience.

For example, while a user is playing a fantasy role-playing game on an XR device, they might encounter a mysterious, glowing sword. Curious about the origins, the user can point at the sword and ask, “What is the story behind this weapon?” In response, the system processes the user's gesture, voice input, and current game state to identify the user's intent. The system then causes a 3D-generated character from the game's world to appear in the user's view. This character, acting as a content companion, can provide a narrated history of the sword, explaining the magical properties and significance to the game's plot, thereby delivering the second content in a diegetic and immersive manner. The model that generates the response can be configured to process the user voice input and map the intent to data associated with the game. In some implementations, the intent can be mapped to information in the repository associated with the game (e.g., a manual for the game).

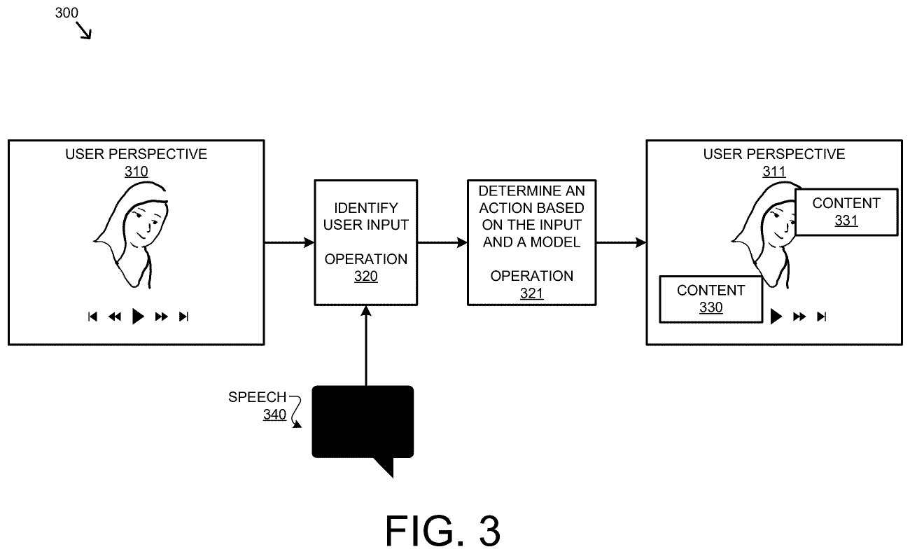

FIG. 3 illustrates an operational scenario 300 of updating a display of content on an XR device according to an implementation. Operational scenario 300 includes user perspective 310, user perspective 311, operation 320, and operation 321. User perspective 311 further includes content 330 and content 331, which is added based on speech 340. Operational scenario 300 can be performed by a system that consists of an XR device or a split computing architecture that includes at least the XR device and one or more additional computing systems. The one or more additional computing systems can consist of servers, desktop computers, companion devices (e.g., smartphones), and the like.

In operational scenario 300, a user is provided with user perspective 310, which includes content for a video, video games, or other content. While providing user perspective 310, the system and operational scenario 300 perform operation 320 to identify user input. In some implementations, operation 320 recognizes user speech using built-in microphones on the XR device and a speech recognition system. The system captures audio input and converts the spoken words into text through a speech-to-text model. An NLP system then analyzes this text to interpret the user's intent for further action within the XR environment. Although demonstrated using speech 340, the system can also identify gestures, controller input, or other input mechanisms for an XR device. In some instances, rather than converting the speech to text, the audio input itself can be processed. For example, the device can use eye-tracking to determine where the user is looking in reference to the first content. The device can perform eye-tracking using infrared cameras and sensors embedded near the lenses to monitor the reflection of light off the user's pupils. This data is processed to determine the direction of the gaze, enabling the device to track where the user is looking in real-time.

After receiving speech 340, the system further performs operation 321 to determine an action based on the input and the model. In some implementations, intent is identified by analyzing user input, such as speech or gestures, through NLP or machine learning models trained to detect patterns and context. The system maps the identified intent to an action using a decision-making framework or action mapping algorithm (e.g., a trained model). Once the intent is matched, the device executes the corresponding action, such as displaying content, interacting with displayed content, or some other action. The content displayed can include videos, three-dimensional objects, or some other object. Here, operation 321 generates and overlays content 330 and content 331 on user perspective 311. In some implementations, as at least one technical effect, the overlay provides a more enriching and immersive experience than the original content in user perspective 310. For example, content 330 and 331 can include behind-the-scenes information indicating how a scene was filmed or information about the actors. The information is displayed based on the input provided by the user and is only offered when determined to be relevant to the user's viewing experience. Although demonstrated as being overlaid in operational scenario 300, content 330 and content 331 can replace the previous content in some examples.

In some implementations, the model that determines the actions from the user input is trained based on the available content for the movie or game. For example, the content for a film can include the video itself and potential extra scenes, behind-the-scenes footage, three-dimensional models, interactive models, text facts, and the like. Similarly, for a game, the content can include videos, the game environment, text facts or suggestions, interactive models, or other types of content associated with the game. Based on the user input (e.g., speech) while playing the game, different portions of the content can be provided to the user.

Configuring the model to take user voice input and implement actions associated with the content can involve collecting a dataset of voice commands paired with corresponding actions or outputs (e.g., displaying different portions of the content). Once the speech is converted to text (or a gesture is converted to a text command), the text is processed by an NLP model, trained to identify user intent from the commands using labeled examples that map inputs (including the content state) to actions. The system learns to interpret and execute actions through supervised learning and reinforcement feedback, ensuring the system can handle variations in phrasing and adapt to different user contexts. The final model can integrate into providing the content, processing real-time voice input to trigger the appropriate responses. For example, when displaying the first content of the content, the user can give input that maps to the second content. The device can then provide the second content as an overlay over the first content or replace the first content.

In some implementations, the second content can comprise text that responds to a user query about the first content. The system can use natural language generation (NLG) by transforming structured data or insights into human-like responses. When a user submits a query, the system processes the query to understand the intent and retrieve relevant content using natural language understanding (NLU) and knowledge bases. The NLG model generates a coherent and contextually appropriate response by structuring the content into a readable and conversational format. The knowledge base is associated with the content (e.g., a knowledge base associated with the content). For example, if a user asks for an actor's name, the device identifies the intent and the actor listed for the scene (or referenced via gesture in the scene when multiple actors are present). Once identified, NLG can provide a summary to the user to respond to the query. Suppose the knowledge base for the content cannot respond. In that case, a web search can be generated from the query, an indication can be displayed to the user that a response is unavailable, or some additional action can be taken.

In some implementations, the input can comprise voice, gesture, or text that provides the second content. The device can use any combination of inputs to identify the user's intent and implement the associated action. For example, the user can provide a gesture combined with voice input that maps to an action associated with the second content.

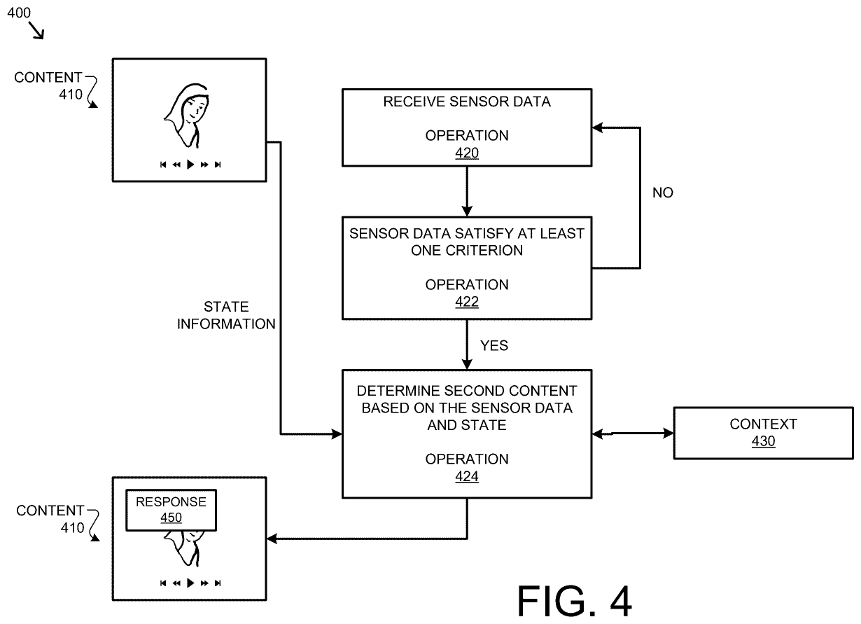

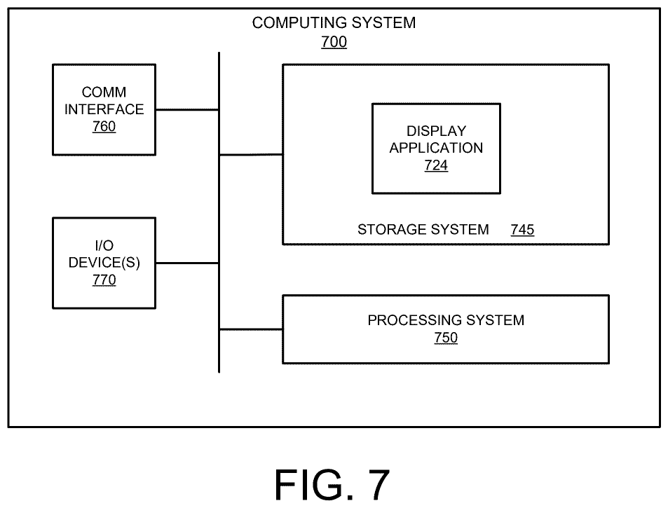

FIG. 4 illustrates an operational scenario 400 of operating a model to select second content according to an implementation. Operational scenario 400 includes content 410, operation 420, operation 422, operation 424, context 430, and response 450. Operational scenario 400 can be performed by a computing device, such as a wearable computing device (e.g., XR device). Operational scenario 400 can be performed by computing system 700 of FIG. 7 in some examples.

In operation 420, sensor data associated with a user request for additional information related to content 410 is received. This sensor data can include various forms of user input, such as voice commands captured by microphones, gestures detected by cameras or motion sensors, controller input from controllers or touchpads, and/or gaze direction determined by eye-tracking sensors. The system monitors these inputs while the user is engaging with content 410 to identify an explicit or implicit request for supplementary content.

From the sensor data, operation 422 determines a user's intent to view second content by processing this sensor data. An intent can be triggered either explicitly, such as through a direct voice command like, “Show me how this scene was made,” or implicitly, through more subtle cues. For example, a user's prolonged gaze fixed on a specific object within content 410 could be interpreted as a sign of interest, triggering the display of related information. Similarly, a pointing gesture toward a character, perhaps combined with an inquisitive vocalization like “Huh?” could be sufficient to signal an intent to access supplementary details about that character, even without a fully formed question. The system processes these varied inputs to infer the user's underlying goal to access additional content. The system can continue monitoring the sensor data if no intent is identified from the user of the device.

When the system determines that the user input requests second content, operation 424 is performed to determine the appropriate second content. Operation 424 can use a model that takes the determined intent from the sensor data and context 430 as inputs. Context 430 can include the current state of the first content, such as a timestamp in a video or a location within a game. Context 430 can further include available information related to the first content, such as a wiki, scripts, production notes, or other data associated with the content. By processing the user's intent in conjunction with this state information and context 430, the model can identify and select the relevant second content to display.

For example, if the first content 410 is a movie and the user points at a specific character while asking, “Who is that?”, operation 424 processes the combined input. The model uses the intent (“identify character”) and the state (e.g., movie timestamp) to query its knowledge base (or context 430). The model then identifies the actor on screen at that moment and selects the appropriate second content, which in this case is a text-based response 450 (an example of second content) providing the actor's name, displayed as an overlay on content 410. Response 450 can further include other information as part of content 410, including other movies for the actor, other scenes for the actor, a history of the character in the movie, or other information. Although demonstrated as providing the second content as a text summary, other types of content can be provided to the user. For example, the second content can comprise another video, such as a behind-the-scenes clip, an interactive three-dimensional model of an object from the first content, or an on-screen character who acts as a media companion. Additionally, the system could utilize an LLM to generate new, text-based responses in real-time by drawing from the specialized knowledge base associated with context 430. The text-based response can be provided via a companion or as a voice that provides context to the user. In some examples, the first content can be paused during the display of the second content. In other implementations, the first content can continue during the display of the second content. In still further examples, the second content can temporarily replace the first content.

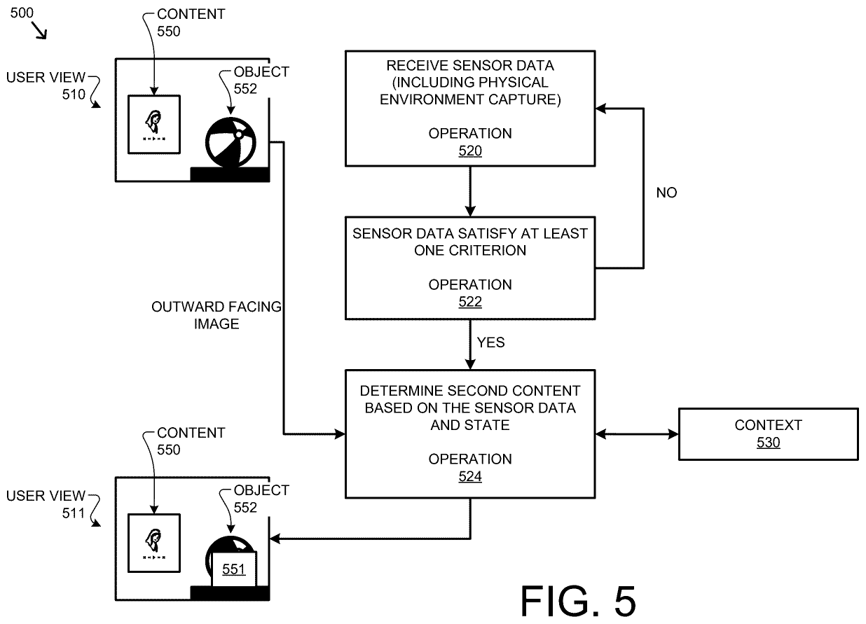

FIG. 5 illustrates an operational scenario 500 of displaying second content on a device according to an implementation. Operational scenario 500 includes user view 510 with content 550 and object 552, wherein object 552 is representative of a physical object visible to a user. Operational scenario 500 further includes user view 511 with content 550, object 552, and content 551. Operational scenario 500 also includes operation 520, operation 522, operation 524, and context 530. Operational scenario 500 can be implemented by a wearable device, such as an XR device, and can be implemented by computing system 700 of FIG. 7 in some examples.

Operational scenario 500 includes, during operation 520, receiving sensor data related to a user's request for information about a physical object 552 in the user's environment, such as an object on a table. This sensor data can include a combination of inputs, such as voice commands from microphones, pointing gestures tracked by motion sensors, and/or gaze direction from eye-tracking sensors. For example, the user might point at object 552 while asking, “What is that?” The device utilizes outward-facing cameras to capture image or video data of object 552 and the surrounding physical space.

In some implementations, the device can include a passthrough display, which can permit a user to view the physical environment, including object 552, either directly through transparent lenses (optical see-through) or via video captured by external cameras and shown on internal screens (video see-through). This allows digital content, such as content 550, to be overlaid onto the user's real-world view, enabling seamless interaction with both physical and virtual elements.

From this sensor data, operation 522 determines the user's intent or determines that the sensor data satisfies at least one criterion associated with a request, which in this case is to get information about object 552. Once the intent is identified, operation 524 is performed to determine the appropriate second content, which is generated by a model trained on the first content 550 (e.g., a movie or game). This operation 524 uses the identified intent and context 530, which can include information from a knowledge base specifically created for content 550 (i.e., context 530), such as scripts, production notes, a Wiki, or another resource. For example, if content 550 is a fantasy movie, and object 552 is a coffee cup, the model might generate a response as content 551 related to the fantasy world, rather than a generic web search result. As a result, in user view 511, second content 551 is displayed, providing information about object 552 that is contextually relevant to the primary content 550 being viewed.

In an illustrative example, suppose content 550 is a nature documentary about marine life, and a user has a physical beach ball (object 552) on a table in their room. The user, pointing at the beach ball, can ask the device, “How does this relate to the ocean?” The system identifies the beach ball via its outward-facing camera and recognizes the user's intent. Instead of providing a generic definition of a beach ball, the model, trained on the documentary's content and other notes associated with the content (context 530), generates a response thematically tied to the documentary. The second content 551 could be a text overlay explaining how ocean currents can carry inflatable objects like beach balls for thousands of miles, tying the user's physical object into the broader ecological themes of the primary content.

In some implementations, content 551 can be delivered as text, a speaking companion who narrates the information, a pre-existing video clip, an interactive three-dimensional model of an object, or as another type of visually displayed content. The speaking companion can be presented as an on-screen character or as a disembodied voice.

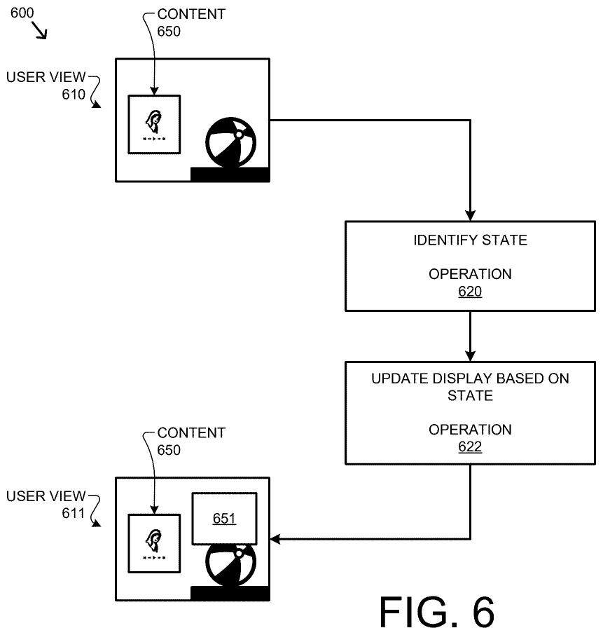

FIG. 6 illustrates an operational scenario 600 of providing a suggested input to a user according to an implementation. Operational scenario 600 includes user view 610 with content 650, user view 611 with content 650 and content 651, operation 620, and operation 622. A wearable device, such as an XR device, can implement operational scenario 600. Operational scenario 600 can be implemented by computing system 700 of FIG. 7 in some examples.

In operational scenario 600, the device performs operation 620 to identify a current state associated with content 650 viewed in user view 610. This state can be a timestamp in a video, a particular location in a game, or any other definable point within the first content. The term state can be defined as a specific, identifiable condition of the first content at a given moment, providing a contextual snapshot for processing user input. For instance, a state can be a particular timestamp in a video, a location within a game, or the set of on-screen elements at a specific point in time. The system can be configured to monitor the content as the content is being displayed to the user to maintain an updated understanding of the content state. For example, if content 650 is a movie, operation 620 tracks the playback progress, allowing the system to know which scene or moment is currently on screen.

Based on the identified state, operation 622 is performed to update the display with recommendations for user input. In some implementations, the content can be associated with metadata that links specific states to potential second content. For instance, the metadata for a movie might specify that at a particular timestamp (or time period), behind-the-scenes footage is available. In this case, operation 622 would cause the display of a recommendation, such as content 651 in user view 611. Content 651 serves as a prompt, suggesting an input the user can provide, like a voice command or gesture, to access the related supplementary information.

The recommendation, content 651, can be designed to be non-intrusive, appearing as an overlay or a subtle visual cue that informs the user of an available interaction without disrupting the primary viewing experience. For example, the prompt might be a small icon or a line of text that appears briefly on the screen, such as, “Ask about the making of this scene,” or “Point here to learn about this character.” This allows the system to proactively guide the user toward interactive elements that are contextually relevant to the current moment in the content.

By linking specific states within the content to suggested inputs, the system can create an interactive layer that enhances user engagement. The user can be made aware of available supplementary content at the most relevant moments, encouraging them to explore the media more deeply. When the user provides an input corresponding to the recommendation in content 651, the system can then retrieve and display the associated second content, providing a seamless and context-aware experience.

In some implementations, the recommendation can be open-ended, permitting the user to provide voice input directed at different objects or elements within the scene. For example, instead of a specific prompt like “Ask about the dragon,” the system could display a more general recommendation, such as, “Curious about something in this scene? Just ask.” This invites the user to inquire about any character, object, or environmental element currently visible. If the user then asks, “What's the story behind that castle?”, the model can process this open-ended query, using the current state to identify the specific castle on screen and retrieve relevant lore or production details from its knowledge base. In some implementations, the recommendation can be personalized based on the user's previous interactions. For instance, if a user has frequently asked questions about a specific actor in earlier movie scenes, the system can proactively display a prompt, such as “Learn more about this actor's role,” when that actor reappears on screen. This dynamic suggestion is based on the user's demonstrated interests, adapting to their behavior to provide a more tailored and engaging experience. In some implementations, the recommendation is based on a model that receives previous user requests and the current state of the content as inputs. Then the model generates a recommendation using a language model.

FIG. 7 illustrates a computing system 700 to manage the display of content based on the positioning of devices according to an implementation. Computing system 700 is representative of any computing system or systems with which the various operational architectures, processes, scenarios, and sequences disclosed herein can be implemented to identify and display supplementary content. Computing system 700 may represent a wearable computing device, such as an XR device or smart glasses. Computing system 700 can include multiple computing devices in some examples, such as a wearable device and a companion device (e.g., a smartphone or tablet). Computing system 700 can also represent any computing device capable of displaying content and receiving user input, such as speech or gestures. Computing system 700 includes storage system 745, processing system 750, communication interface 760, and input/output (I/O) device(s) 770. Processing system 750 is operatively linked to communication interface 760, I/O device(s) 770, and storage system 745. In some implementations, communication interface 760 and/or I/O device(s) 770 may be communicatively linked to storage system 745. Computing system 700 may further include other components, such as a battery and enclosure, that are not shown for clarity.

Communication interface 760 comprises components that communicate over communication links, such as network cards, ports, radio frequency, processing circuitry and software, or some other communication devices. Communication interface 760 may be configured to communicate over metallic, wireless, or optical links. Communication interface 760 may be configured to use Time Division Multiplex (TDM), Internet Protocol (IP), Ethernet, optical networking, wireless protocols, communication signaling, or some other communication format, including combinations thereof. Communication interface 760 may be configured to communicate with external devices, such as servers, user devices, or some other computing device.

I/O device(s) 770 may include computer peripherals that facilitate the interaction between the user and computing system 700. Examples of I/O device(s) 770 may include keyboards, mice, trackpads, monitors, displays, printers, cameras, microphones, external storage devices, and the like.

Processing system 750 comprises microprocessor circuitry (e.g., at least one processor) and other circuitry that retrieves and executes operating software from storage system 745. Storage system 745 may include volatile and nonvolatile, removable, and non-removable media implemented in any method or technology for information storage, such as computer-readable instructions, data structures, program modules, or other data. Storage system 745 may be implemented as a single storage device, but may also be implemented across multiple storage devices or sub-systems. Storage system 745 may comprise additional elements, such as a controller to read operating software from the storage systems. Examples of storage media (also referred to as computer-readable storage media) include random access memory, read-only memory, magnetic disks, optical disks, and flash memory, as well as any combination or variation thereof or any other type of storage media. In some implementations, the storage media may be non-transitory. In some instances, at least a portion of the storage media may be transitory. In no case is the storage media a propagated signal.

Processing system 750 is typically mounted on a circuit board that may hold the storage system. The operating software of storage system 745 comprises computer programs, firmware, or another form of machine-readable program instructions. The operating software of storage system 745 comprises display application 724. The operating software on storage system 745 may include an operating system, utilities, drivers, network interfaces, applications, or other types of software. When read and executed by processing system 750, the operating software on storage system 745 directs computing system 700 to operate as described in the previously described FIGS. 1-6.

In at least one implementation, display application 724 directs processing system 750 to cause a display of first content, such as a video or a game, and to monitor for user input. The input can include voice commands, gestures, gaze, or controller input detected via I/O device(s) 770 and communication interface 760. The display application 724 processes the input to determine a user's intent and identifies a current state of the first content, such as a timestamp in a video or a location in a game.

Based on the user's input and the current state of the first content, display application 724 can use a model to obtain second content. This model can be trained on the first content and its associated data, enabling the model to provide contextually relevant supplementary information. The model processes the combination of the user's intent and the content's state to select or generate the appropriate second content. This process can ensure that the information provided is directly related to what the user is experiencing at that moment.

Additionally, display application 724 can cause a second display of the second content on the device. The second content can take various forms, including video clips, interactive three-dimensional objects, or text-based information. This second content can be overlaid on the first content, temporarily replace it, or be presented by an on-screen character, thereby creating a more interactive and immersive experience for the user without disrupting the primary viewing session.

Below are example clauses associated with the present disclosure. The described clauses should not be considered exhaustive.

Clause 1. A method comprising: causing a first display of first content on a device; identifying an input from a user of the device; in response to identifying the input, identifying a state of the first content; obtaining second content from a model, the model configured to determine the second content based on the input and the state of the first content; and causing a second display of the second content on the device.

Clause 2. The method of clause 1, wherein the state of the first content comprises a first state of the first content, and wherein the method further comprises: identifying a second state of the first content; determining a recommendation based on the second state of the first content; and displaying the recommendation on the device.

Clause 3. The method of clause 1, wherein causing the second display of the second content comprises replacing the first content with the second content.

Clause 4. The method of clause 1, wherein the first content comprises a video, and wherein the state comprises a timestamp in the video.

Clause 5. The method of clause 1, wherein causing the second display of the second content on the device comprises: overlaying the second content on at least a portion of the first content.

Clause 6. The method of clause 1 further comprising: identifying a gaze associated with the user, wherein the model is further configured to determine the second content based on the gaze.

Clause 7. The method of clause 1, wherein the second content comprises natural language generated by the model, and wherein the model is further configured to determine the second content based on a knowledge base associated with the first content.

Clause 8. The method of clause 1, wherein the input comprises a reference to a physical object in an environment for the user of the device.

Clause 9. A computing system comprising: at least one processor; a computer-readable storage medium operatively coupled to the at least one processor; and program instructions stored on the computer-readable storage medium that, when executed by the at least one processor, direct the computing system to perform method, the method comprising: causing a first display of first content on a device; identifying an input from a user of the device; in response to identifying the input, identifying a state of the first content; obtaining second content from a model, the model configured to determine the second content based on the input and the state of the first content; and causing a second display of the second content on the device.

Clause 10. The computing system of clause 9, wherein the state of the first content comprises a first state of the first content, and wherein the method further comprises: identifying a second state of the first content; determining a recommendation based on the second state of the first content; and displaying the recommendation on the device.

Clause 11. The computing system of clause 9, wherein causing the second display of the second content comprises replacing the first content with the second content.

Clause 12. The computing system of clause 9, wherein the first content comprises a video, and wherein the state comprises a timestamp in the video.

Clause 13. The computing system of clause 9, wherein causing the second display of the second content on the device comprises: overlaying the second content on at least a portion of the first content.

Clause 14. The computing system of clause 9, wherein the method further comprises: identifying a gaze associated with the user, wherein the model is further configured to determine the second content based on the gaze.

Clause 15. The computing system of clause 9, wherein the second content comprises natural language generated by the model.

Clause 16. The computing system of clause 9, wherein the input comprises a reference to a physical object in an environment for the user of the device.

Clause 17. A computer-readable storage medium having program instructions stored thereon that, when executed by at least one processor, direct the at least one processor to perform a method, the method comprising: causing a first display of first content on a device; identifying an input from a user of the device; in response to identifying the input, identifying a state of the first content; obtaining second content from a model, the model configured to determine the second content based on the input and the state of the first content; and causing a second display of the second content on the device.

Clause 18. The computer-readable storage medium of clause 17, wherein the state of the first content comprises a first state of the first content, and wherein the method further comprises: identifying a second state of the first content; determining a recommendation based on the second state of the first content; and displaying the recommendation on the device.

Clause 19. The computer-readable storage medium of clause 17, wherein causing the second display of the second content on the device comprises: overlaying the second content on at least a portion of the first content.

Clause 20. The computer-readable storage medium of clause 17, wherein the method further comprises: identifying a gaze associated with the user, wherein the model is further configured to determine the second content based on the gaze.

In accordance with aspects of the disclosure, implementations of various techniques and methods described herein may be implemented in digital electronic circuitry, or in computer hardware, firmware, software, or in combinations of them. Implementations may be implemented as a computer program product (e.g., a computer program tangibly embodied in an information carrier, a machine-readable storage device, a computer-readable medium, a tangible computer-readable medium), for processing by, or to control the operation of, data processing apparatus (e.g., a programmable processor, a computer, or multiple computers). In some implementations, a tangible computer-readable storage medium may be configured to store instructions that, when executed, cause a processor to perform a process. A computer program, such as the computer program(s) described above, may be written in any form of programming language, including compiled or interpreted languages, and may be deployed in any form, including as a standalone program or as a module, component, subroutine, or other unit suitable for use in a computing environment. A computer program may be deployed to be processed on one computer or on multiple computers at one site or distributed across multiple sites and interconnected by a communication network.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the implementations. They have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

It will be understood that, in the foregoing description, when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application, if any, may be amended to recite example relationships described in the specification or shown in the figures.

As used in this specification, a singular form may, unless definitively indicating a particular case in terms of the context, include a plural form. Spatially relative terms (e.g., over, above, upper, under, beneath, below, lower, and so forth) are intended to encompass different orientations of the device in use or operation in addition to the orientation depicted in the figures. In some implementations, the relative terms above and below can, respectively, include vertically above and vertically below. In some implementations, the term adjacent can include laterally adjacent to or horizontally adjacent to.

What is claimed is:

1. A method comprising:
causing display of first content on a device;
identifying an input from a user of the device;
in response to identifying the input, identifying a state of the first content;
obtaining second content from a model, the model configured to determine the second content based on the input and the state of the first content; and
causing display of the second content on the device.

2. The method of claim 1, wherein the state of the first content comprises a first state of the first content, and wherein the method further comprises:
identifying a second state of the first content;
determining a recommendation based on the second state of the first content; and
displaying the recommendation on the device,
wherein receiving the input from the user comprises receiving the input based on the recommendation.

3. The method of claim 1, wherein causing the display of the second content comprises replacing the first content with the second content.

4. The method of claim 1, wherein the first content comprises a video, and wherein the state comprises a timestamp in the video.

5. The method of claim 1, wherein causing the display of the second content on the device comprises:
overlaying the second content on at least a portion of the first content.

6. The method of claim 1 further comprising:
identifying a gaze associated with the user,
wherein the model is further configured to determine the second content based on the gaze.

7. The method of claim 1, wherein the second content comprises natural language generated by the model, and wherein the model is further configured to determine the second content based on a knowledge base associated with the first content.

8. The method of claim 1, wherein the input comprises a reference to a physical object in an environment for the user of the device.

9. A computing system comprising:
at least one processor;
a computer-readable storage medium operatively coupled to the at least one processor; and
program instructions stored on the computer-readable storage medium that, when executed by the at least one processor, direct the computing system to perform method, the method comprising:
causing display of first content on a device;
identifying an input from a user of the device;
in response to identifying the input, identifying a state of the first content;
obtaining second content from a model, the model configured to determine the second content based on the input and the state of the first content; and
causing display of the second content on the device.

10. The computing system of claim 9, wherein the state of the first content comprises a first state of the first content, and wherein the method further comprises:
identifying a second state of the first content;
determining a recommendation based on the second state of the first content; and
displaying the recommendation on the device,
wherein receiving the input from the user comprises receiving the input based on the recommendation.

11. The computing system of claim 9, wherein causing the display of the second content comprises replacing the first content with the second content.

12. The computing system of claim 9, wherein the first content comprises a video, and wherein the state comprises a timestamp in the video.

13. The computing system of claim 9, wherein causing the display of the second content on the device comprises:
overlaying the second content on at least a portion of the first content.

14. The computing system of claim 9, wherein the method further comprises:
identifying a gaze associated with the user,
wherein the model is further configured to determine the second content based on the gaze.

15. The computing system of claim 9, wherein the second content comprises natural language generated by the model.

16. The computing system of claim 9, wherein the input comprises a reference to a physical object in an environment for the user of the device.

17. A computer-readable storage medium having program instructions stored thereon that, when executed by at least one processor, direct the at least one processor to perform a method, the method comprising:
causing display of first content on a device;
identifying an input from a user of the device;
in response to identifying the input, identifying a state of the first content;
obtaining second content from a model, the model configured to determine the second content based on the input and the state of the first content; and
causing display of the second content on the device.

18. The computer-readable storage medium of claim 17, wherein the state of the first content comprises a first state of the first content, and wherein the method further comprises:
identifying a second state of the first content;
determining a recommendation based on the second state of the first content; and
displaying the recommendation on the device,
wherein receiving the input from the user comprises receiving the input based on the recommendation.

19. The computer-readable storage medium of claim 17, wherein causing the display of the second content on the device comprises:
overlaying the second content on at least a portion of the first content.

20. The computer-readable storage medium of claim 17, wherein the method further comprises:
identifying a gaze associated with the user,
wherein the model is further configured to determine the second content based on the gaze.
